(19) United States
(12) Patent Application Publication
(10) Pub. No.: US 2023/0370492 A1
(43) Pub. Date: Nov. 16, 2023

(54) IDENTIFY AND BLOCK DOMAINS USED FOR NXNS-BASED DDOS ATTACK

(71) Applicant: Palo Alto Networks, Inc., Santa Clara, CA (US)

(72) Inventors: Ruian Duan, Santa Clara, CA (US); Daiping Liu, San Jose, CA (US)

(21) Appl. No.: 17/826,766

(22) Filed: May 27, 2022

Related U.S. Application Data
(60) Provisional application No. 63/340,312, filed on May 10, 2022.

(51) Int. Cl. H04L 9/40

(52) U.S. Cl. CPC H04L 63/1458; H04L 63/1416

(57) ABSTRACT

Techniques for identifying and blocking domains used for NXNS-based distributed denial of service (DDos) attacks are disclosed. An analysis of DNS data is performed to identify a candidate attack domain associated with an NXNS attack. The candidate attack domain is confirmed as a confirmed attack domain based at least in part on a validation.

### CROSS REFERENCE TO OTHER APPLICATIONS

This application claims priority to U.S. Provisional Patent Application No. 63/340,312 entitled IDENTIFY AND BLOCK DOMAINS USED FOR NXNS-BASED DDOS ATTACKS filed May 10, 2022 which is incorporated herein by reference for all purposes.

### BACKGROUND OF THE INVENTION

Nefarious individuals attempt to harm computer systems in a variety of ways. As one example, such individuals may embed or otherwise include malicious software (“malware”) in email attachments and transmit (or cause the malware to be transmitted) to unsuspecting users. When executed, the malware compromises the victim's computer. Some types of malware will instruct a compromised computer to communicate with a remote host. For example, malware can turn a compromised computer into a “bot” in a “botnet,” receiving instructions from and/or reporting data to a command and control (C&C) server under the control of the nefarious individual. Such compromised computers can be used to perform a variety of tasks (e.g., initiating attacks against other systems). Unfortunately, attackers continue to adapt their techniques to evade detection. Accordingly, there exists an ongoing need for improved approaches to detecting malicious computer activities and preventing harm to computer systems.

### BRIEF DESCRIPTION OF THE DRAWINGS

Various embodiments of the invention are disclosed in the following detailed description and the accompanying drawings.

FIG. 1A illustrates an example of an environment in which malicious use of NoneXistent NameServer (NXNS) domains is detected and the harm posed by such domains reduced.

FIG. 1B illustrates an embodiment of a data appliance.

FIG. 1C is a functional diagram of logical components of an embodiment of a data appliance.

FIG. 2 illustrates an embodiment of a security platform.

FIG. 3 illustrates various events that happen in a benign and malicious DNS resolution scenarios.

FIG. 4A is a representation of a portion of passive DNS information.

FIG. 4B illustrates an example of a set of valid NS records that can be extracted from passive DNS information.

FIG. 4C illustrates a domain to nameserver mapping that can be extracted from passive DNS information.

FIG. 5 illustrates various examples of data used by a passive DNS analyzer to determine candidate attack domains in various embodiments.

FIG. 6 illustrates an embodiment of a process for identifying an attack domain associated with an NXNS attack.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

### I. OVERVIEW

A firewall generally protects networks from unauthorized access while permitting authorized communications to pass through the firewall. A firewall is typically a device, a set of devices, or software executed on a device that provides a firewall function for network access. For example, a firewall can be integrated into operating systems of devices (e.g., computers, smart phones, or other types of network communication capable devices). A firewall can also be integrated into or executed as one or more software applications on various types of devices, such as computer servers, gateways, network/routing devices (e.g., network routers), and data appliances (e.g., security appliances or other types of special purpose devices), and in various implementations, certain operations can be implemented in special purpose hardware, such as an ASIC or FPGA.

Firewalls typically deny or permit network transmission based on a set of rules. These sets of rules are often referred to as policies (e.g., network policies or network security policies). For example, a firewall can filter inbound traffic by applying a set of rules or policies to prevent unwanted outside traffic from reaching protected devices. A firewall can also filter outbound traffic by applying a set of rules or policies (e.g., allow, block, monitor, notify or log, and/or other actions can be specified in firewall rules or firewall policies, which can be triggered based on various criteria, such as are described herein). A firewall can also filter local network (e.g., intranet) traffic by similarly applying a set of rules or policies.

Security devices (e.g., security appliances, security gateways, security services, and/or other security devices) can include various security functions (e.g., firewall, anti-malware, intrusion prevention/detection, Data Loss Prevention (DLP), and/or other security functions), networking functions (e.g., routing, Quality of Service (QoS), workload balancing of network related resources, and/or other networking functions), and/or other functions. For example, routing functions can be based on source information (e.g., IP address and port), destination information (e.g., IP address and port), and protocol information.

A basic packet filtering firewall filters network communication traffic by inspecting individual packets transmitted over a network (e.g., packet filtering firewalls or first generation firewalls, which are stateless packet filtering firewalls). Stateless packet filtering firewalls typically inspect the individual packets themselves and apply rules based on the inspected packets (e.g., using a combination of a packet's source and destination address information, protocol information, and a port number).

Application firewalls can also perform application layer filtering (e.g., application layer filtering firewalls or second generation firewalls, which work on the application level of the TCP/IP stack). Application layer filtering firewalls or application firewalls can generally identify certain applications and protocols (e.g., web browsing using HyperText Transfer Protocol (HTTP), a Domain Name System (DNS) request, a file transfer using File Transfer Protocol (FTP), and various other types of applications and other protocols, such as Telnet, DHCP, TCP, UDP, and TFTP (GSS)). For example, application firewalls can block unauthorized protocols that attempt to communicate over a standard port (e.g., an unauthorized/out of policy protocol attempting to sneak through by using a non-standard port for that protocol can generally be identified using application firewalls).

Stateful firewalls can also perform state-based packet inspection in which each packet is examined within the context of a series of packets associated with that network transmission's flow of packets. This firewall technique is generally referred to as a stateful packet inspection as it maintains records of all connections passing through the firewall and is able to determine whether a packet is the start of a new connection, a part of an existing connection, or is an invalid packet. For example, the state of a connection can itself be one of the criteria that triggers a rule within a policy.

Advanced or next generation firewalls can perform stateless and stateful packet filtering and application layer filtering as discussed above. Next generation firewalls can also perform additional firewall techniques. For example, certain newer firewalls sometimes referred to as advanced or next generation firewalls can also identify users and content. In particular, certain next generation firewalls are expanding the list of applications that these firewalls can automatically identify to thousands of applications. Examples of such next generation firewalls are commercially available from Palo Alto Networks, Inc. (e.g., Palo Alto Networks' PA Series firewalls). For example, Palo Alto Networks' next generation firewalls enable enterprises to identify and control applications, users, and content—not just ports, IP addresses, and packets—using various identification technologies, such as the following: APP-ID for accurate application identification, User-ID for user identification (e.g., by user or user group), and Content-ID for real-time content scanning (e.g., controlling web surfing and limiting data and file transfers). These identification technologies allow enterprises to securely enable application usage using business-relevant concepts, instead of following the traditional approach offered by traditional port-blocking firewalls. Also, special purpose hardware for next generation firewalls (implemented, for example, as dedicated appliances) generally provides higher performance levels for application inspection than software executed on general purpose hardware (e.g., such as security appliances provided by Palo Alto Networks, Inc., which use dedicated, function specific processing that is tightly integrated with a single-pass software engine to maximize network throughput while minimizing latency).

Advanced or next generation firewalls can also be implemented using virtualized firewalls. Examples of such next generation firewalls are commercially available from Palo Alto Networks, Inc. (e.g., Palo Alto Networks' VM Series firewalls, which support various commercial virtualized environments, including, for example, VMware® ESXi™ and NSX™, Citrix® Netscaler SDX™, KVM/OpenStack (Centos/RHEL, Ubuntu®), and Amazon Web Services (AWS)). For example, virtualized firewalls can support similar or the exact same next-generation firewall and advanced threat prevention features available in physical form factor appliances, allowing enterprises to safely enable applications flowing into, and across their private, public, and hybrid cloud computing environments. Automation features such as V1\4 monitoring, dynamic address groups, and a REST-based API allow enterprises to proactively monitor VM changes, dynamically feeding that context into security policies, thereby eliminating the policy lag that may occur when VMs change.

### II. EXAMPLE ENVIRONMENT

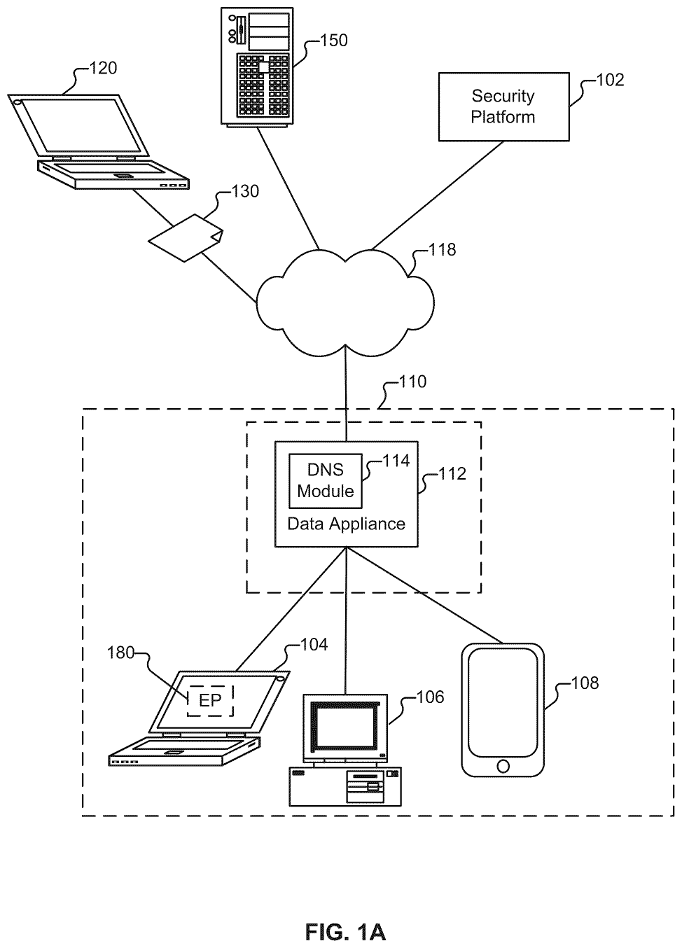

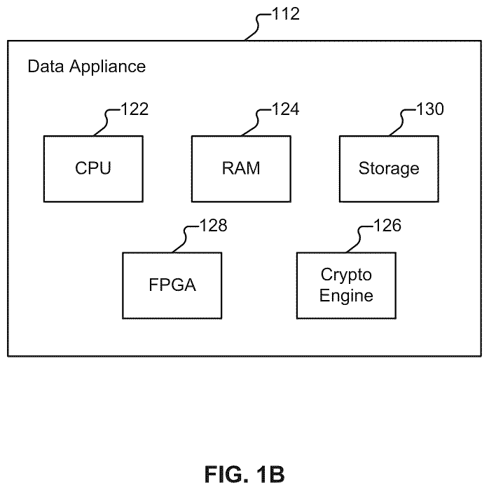

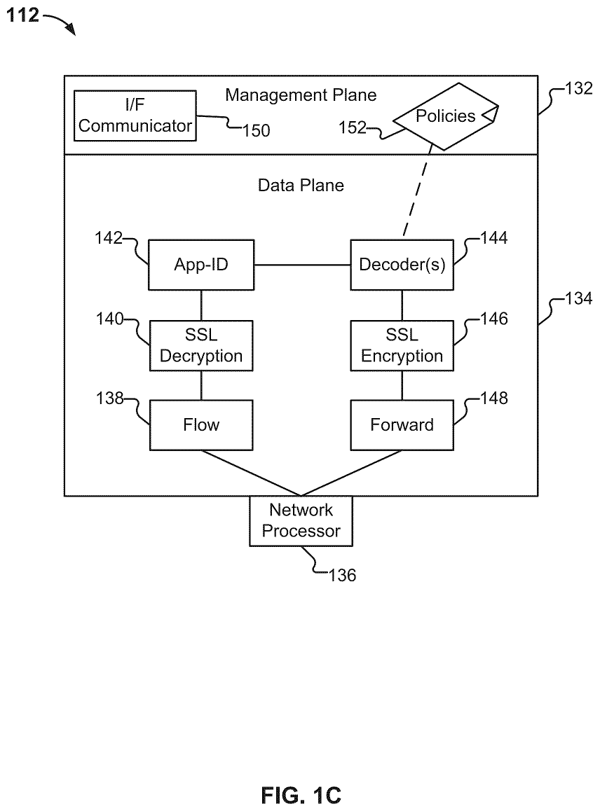

FIG. 1A illustrates an example of an environment in which malicious use of NoneXistent NameServer (NXNS) domains is detected and the harm posed by such domains reduced. Using techniques described herein, DNS record query information is used to identify servers (also referred to herein as “attack domains”) that exploit the design of recursive resolvers, e.g., to launch distributed denial of service (DDOS) attacks. Identification of attack domains can be used in a variety of beneficial ways. As one example, a list of attack domains can be provided to firewalls, intrusion detection systems, intrusion prevention systems, or other appropriate appliances. If a client device protected by such an appliance performs DNS queries that correspond to an attack domain, such behavior can be treated as suspicious/malicious by the appliance, and remedial actions can be taken.

In the example environment shown in FIG. 1A, client devices 104-108 are a laptop computer, a desktop computer, and a tablet (respectively) present in an enterprise network 110. Data appliance 112 is configured to enforce policies regarding communications between clients, such as clients 104 and 106, and nodes outside of enterprise network 110 (e.g., reachable via external network 118). Examples of such policies include ones governing traffic shaping, quality of service, and routing of traffic. Other examples of policies include security policies such as ones requiring the scanning for threats in incoming (and/or outgoing) email attachments, website content, files exchanged through instant messaging programs, and/or other file transfers. In some embodiments, appliance 112 is also configured to enforce policies with respect to traffic that stays within enterprise network 110.

Although illustrated as a single element in FIG. 1A, enterprise network 110 can comprise multiple networks, any/each of which can include one or multiple data appliances or other components that embody techniques described herein. For example, the techniques described herein can be deployed by large, multi-national companies (or other entities) with multiple offices in multiple geographical locations. And, while client devices 104-108 are illustrated in FIG. 1A as connecting directly to data appliance 112, it is to be understood that one or more intermediate nodes (e.g., routers, switches, and/or proxies) can be and typically are interposed between various elements in enterprise network 110.

Appliance 112 can take a variety of forms. For example, appliance 112 can comprise a dedicated device or set of devices. The functionality provided by appliance 112 can also be integrated into or executed as software on a general purpose computer, a computer server, a gateway, and/or a network/routing device. In some embodiments, services provided by data appliance 112 are instead (or in addition) provided to client 104 by software executing on client 104.

In the example shown in FIG. 1A, a malicious individual (using system 120) has created malware 130. The malicious individual hopes that a client device, such as client device 104, will execute a copy of malware 130, compromising the client device and, for example, causing the client device to become a bot in a botnet. The compromised client device can then be instructed to perform tasks (e.g., participating in DDOS attacks) and to report information to an external entity, such as command and control (C&C) server 150, as well as to receive instructions from C&C server 150, as applicable.

In various embodiments, appliance 112 is configured to work in cooperation with a security platform (e.g., platform 102). As one example, platform 102 can provide to appliance 112 a set of signatures of known-malicious files (e.g., as part of a subscription). If a signature for malware 130 is included in the set, appliance 112 can prevent the transmission of malware 130 to client 104 accordingly. As another example, platform 102 can provide to appliance 112 a list of known malicious domains, allowing appliance 112 to block traffic between network 110 and (for example) C&C server 150. The list of malicious domains can also help appliance 112 determine when one of its nodes has been compromised. For example, if client 104 attempts to contact C&C server 150, such attempt is a strong indicator that client 104 has been compromised by malware (and remedial actions should be taken accordingly, such as quarantining client 104 from communicating with other nodes within network 110).

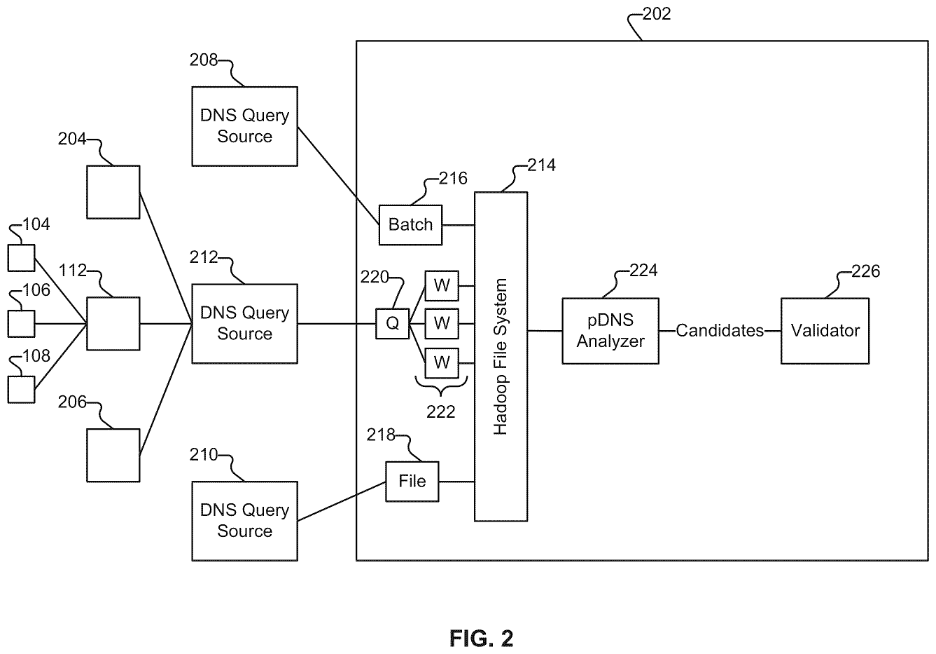

In various embodiments, data appliance 112 includes a DNS module 114, which is configured to receive (e.g., from security platform 102) a list of domains (e.g., a list of attack domains and/or a list of NXNS domains) for which queries (e.g., made by client device 104), if observed (e.g., within network 110), are problematic. DNS module 114 can also be configured to send (e.g., to platform 102) DNS query data (e.g., logs of DNS requests made by clients such as clients 104-108). DNS module 114 can be integrated into appliance 112 (as shown in FIG. 1A) and can also operate as a standalone appliance in various embodiments. And, as with other components shown in FIGS. 1A-2, DNS module 114 can be provided by the same entity that provides appliance 112 (and/or security platform 102), and can also be provided by a third party (e.g., one that is different from the provider of appliance 112 or security platform 102). Further, as with other elements of appliance 112, in various embodiments, the functionality provided by DNS module 114 (or portions thereof) is instead/in addition provided by software executing on a client (e.g., client 104).

An embodiment of a data appliance is shown in FIG. 1B. The example shown is a representation of physical components that are included in data appliance 112, in various embodiments. Specifically, data appliance 112 includes a high performance multi-core Central Processing Unit (CPU) 122 and Random Access Memory (RAM) 124. Data appliance 112 also includes a storage 130 (such as one or more hard disks or solid state storage units). In various embodiments, data appliance 112 stores (whether in RAM 124, storage 130, and/or other appropriate locations) information used in monitoring enterprise network 110 and implementing disclosed techniques. Examples of such information include application identifiers, content identifiers, user identifiers, requested URLs, IP address mappings, policy and other configuration information, signatures, hostname/URL categorization information, malware profiles, and machine learning models. Data appliance 112 can also include one or more optional hardware accelerators. For example, data appliance 112 can include a cryptographic engine 126 configured to perform encryption and decryption operations, and one or more Field Programmable Gate Arrays (FPGAs) 128 configured to perform matching, act as network processors, and/or perform other tasks.

Functionality described herein as being performed by data appliance 112 can be provided/implemented in a variety of ways. For example, data appliance 112 can be a dedicated device or set of devices. The functionality provided by data appliance 112 can also be integrated into or executed as software on a general purpose computer, a computer server, a gateway, and/or a network/routing device. In some embodiments, at least some services described as being provided by data appliance 112 are instead (or in addition) provided to a client device (e.g., client device 104) by software executing on the client device (e.g., endpoint protection application 180).

Whenever data appliance 112 is described as performing a task, a single component, a subset of components, or all components of data appliance 112 may cooperate to perform the task. Similarly, whenever a component of data appliance 112 is described as performing a task, a subcomponent may perform the task and/or the component may perform the task in conjunction with other components. In various embodiments, portions of data appliance 112 are provided by one or more third parties. Depending on factors such as the amount of computing resources available to data appliance 112, various logical components and/or features of data appliance 112 may be omitted and the techniques described herein adapted accordingly. Similarly, additional logical components/features can be included in embodiments of data appliance 112 as applicable. One example of a component included in data appliance 112 in various embodiments is an application identification engine which is configured to identify an application (e.g., using various application signatures for identifying applications based on packet flow analysis). For example, the application identification engine can determine what type of traffic a session involves, such as Web Browsing—Social Networking; Web Browsing —News; SSH; and so on.

FIG. 1C is a functional diagram of logical components of an embodiment of a data appliance. The example shown is a representation of logical components that can be included in data appliance 112 in various embodiments. Unless otherwise specified, various logical components of data appliance 112 are generally implementable in a variety of ways, including as a set of one or more scripts (e.g., written in Java, python, etc., as applicable).

As shown, data appliance 112 comprises a firewall, and includes a management plane 132 and a data plane 134. The management plane is responsible for managing user interactions, such as by providing a user interface for configuring policies and viewing log data. The data plane is responsible for managing data, such as by performing packet processing and session handling.

Network processor 136 is configured to receive packets from client devices, such as client device 108, and provide them to data plane 134 for processing. Whenever flow module 138 identifies packets as being part of a new session, it creates a new session flow. Subsequent packets will be identified as belonging to the session based on a flow lookup. If applicable, SSL decryption is applied by SSL decryption engine 140. Otherwise, processing by SSL decryption engine 140 is omitted. Decryption engine 140 can help data appliance 112 inspect and control SSL/TLS and SSH encrypted traffic, and thus help to stop threats that might otherwise remain hidden in encrypted traffic. Decryption engine 140 can also help prevent sensitive content from leaving enterprise network 110. Decryption can be controlled (e.g., enabled or disabled) selectively based on parameters such as: URL category, traffic source, traffic destination, user, user group, and port. In addition to decryption policies (e.g., that specify which sessions to decrypt), decryption profiles can be assigned to control various options for sessions controlled by the policy. For example, the use of specific cipher suites and encryption protocol versions can be required.

Application identification (APP-ID) engine 142 is configured to determine what type of traffic a session involves. As one example, application identification engine 142 can recognize a GET request in received data and conclude that the session requires an HTTP decoder. In some cases, e.g., a web browsing session, the identified application can change, and such changes will be noted by data appliance 112. For example, a user may initially browse to a corporate Wiki (classified based on the URL visited as “Web Browsing—Productivity”) and then subsequently browse to a social networking site (classified based on the URL visited as “Web Browsing—Social Networking”). Different types of protocols have corresponding decoders 144.

Based on the determination made by application identification engine 142, the packets are sent to an appropriate decoder 144. Decoder 144 is configured to assemble packets (which may be received out of order) into the correct order, perform tokenization, and extract out information. Decoder 144 also performs signature matching to determine what should happen to the packet. As needed, SSL encryption engine 146 can re-encrypt decrypted data. Packets are forwarded using a forward module 148 for transmission (e.g., to a destination).

As also shown in FIG. 1C, policies 152 are received and stored in management plane 132. Policies can include one or more rules, which can be specified using domain and/or host/server names, and rules can apply one or more signatures or other matching criteria or heuristics, such as for security policy enforcement for subscriber/IP flows based on various extracted parameters/information from monitored session traffic flows. An interface (I/F) communicator 150 is provided for management communications (e.g., via (REST) APIs, messages, or network protocol communications or other communication mechanisms).

FIG. 2 illustrates an embodiment of a security platform. Security platform 202 is an embodiment of security platform 102. Security platform 202 can be implemented in a variety of ways. As shown, security platform 202 makes use of commercially available public cloud resources, such as Amazon Web Services and/or Google Cloud Platform resources. Other platform resources provided by other vendors can also be used, as applicable (e.g., as offered by Microsoft), as can (in various embodiments) commodity server-class hardware.

Security platform 202 receives DNS query information (e.g., passive DNS data) from a variety of sources (208-212), using a variety of techniques. Sources 208-212 collectively provide platform 202 with approximately five billion unique records each day. An example of a record is:
abc.com A 199.181.132.250 2022-01-01 12:30:49

The record indicates that, on Jan. 1, 2022, a DNS query was made for the site “abc.com” and at that time, the response provided was the IP address “199.181.132.250” (an “Address record” or “A record”). As used throughout the Specification, references to an “A record” can include both IPv4 (A) address records and IPv6 (AAAA) address records, based, for example, on implementation. In some cases, additional information can also be included. For example, an IP address associated with the requestor may be included in the passive DNS, or may be omitted (e.g., due to privacy reasons). Another example of a record is:
xyz.abc.com NS ns.abc.com 199.123.12.12 2022-01-02 00:30:30

The record indicates that, on Jan. 2, 2022, a DNS query was made for the site “xyz.abc.com” and at that time, the response provided (also referred to as a “referral response” or “Nameserver (NS) record”) was to query the nameserver at ns.abc.com for more information about “xyz.abc.com.”

Source 208 is a real-time feed of globally collected passive DNS. An example of such a source is Farsight Security Passive DNS. In particular, records from source 208 are provided to platform 202 via an nmsgtool client, which is a utility wrapper for the libnmsg API that allows messages to be read/written across a network. Every 30 minutes, a batch process 216 (e.g., implemented using python) loads records newly received from source 208 into an Apache Hadoop cluster (HDFS) 214.

Source 210 is a daily feed of passive DNS associated with malware. An example of such a source is the Georgia Tech Information Security Center's Malware Passive DNS Data Daily Feed. Records from source 210 are provided to platform 202 as a single file via scp and then copied into HDFS 214 (e.g., using copyFromLocal on the file location 218 (e.g., a particular node in a cluster configured to receive data from source 210)).

As previously mentioned, appliance 112 can collect DNS queries made by clients 104-108 and provide passive DNS data to platform 202. In some embodiments, appliances such as appliance 112 directly provide the passive DNS information to platform 202. In other embodiments, appliance 112 (along with many other appliances) provides the passive DNS information to an intermediary, which in turn provides the information to platform 202. In the example shown in FIG. 2, appliance 112, along with other appliances, such as appliances 204 and 206 (and thousands of other appliances, not pictured), provide their collected DNS information to a server, which in turn provides the collected information (as source 212) to platform 202. In particular, source 212 provides the collected DNS information to a queue service 220 which in turn uses a set of workers 222 to copy records into HDFS 214. Other technologies can also be used to copy records into HDFS 214, such as Apache Kafka. In various embodiments, the DNS information provided to platform 202 arrives filtered (e.g., by data appliances such as data appliance 112, by server/source 212, or both). One example of such filtering includes filtering out DNS information associated with DNS requests for known benign domains, and/or popular websites. Domain whitelists (e.g., provided to appliance 112 by platform 102) and the Alexa top 1,000 (or other) sites are examples of filters that can be used. Another example of a filter includes one specified by an administrator of appliance 112 (e.g., to prevent local DNS query information from leaving network 110).

### III. NXNS-BASED DDOS ATTACKS

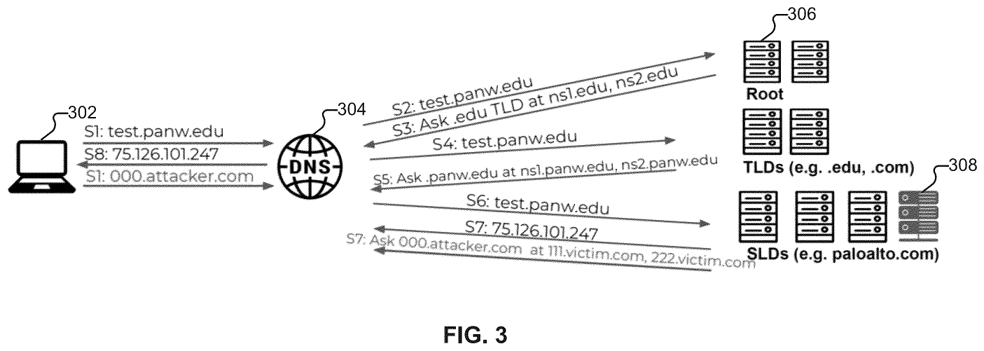

FIG. 3 illustrates various events that happen in a typical (benign) DNS resolution scenario, as well as how an attack can be perpetrated by maliciously taking advantage of DNS resolution inefficiencies and vulnerabilities. Suppose a user (hereinafter also referred to as “Alice”) of a client device (302) would like to visit a website “test.panw.edu.” In the benign example depicted in FIG. 3, she enters that domain into her browser and (assuming a resolution of the domain is not already locally cached) a DNS lookup query is performed against resolver 304 (S1). If resolver 304 does not have a resolution cached, it recursively queries authoritative nameservers to attempt to obtain an answer (e.g., an IP address).

As shown in FIG. 3, resolver 304 first queries a root server (e.g., root server 306) with the domain, “test.panw.edu” (S2). Root server 306 does not have an A record for test.panw.edu, and responds with NS information (S3) indicating that resolver 304 should query applicable top level domain (TLD) nameservers—in this case, “ns1.edu” and “ns2.edu.” Resolver 304 queries the applicable TLD nameservers (S4), which also do not have A records for test.panw.edu, and respond with NS information (S5) indicating that resolver 304 should query applicable second level (SLD) nameservers—in this case, “ns1.panw.edu” and “ns2.panw.edu.” Resolver 304 queries the applicable SLD nameservers (S6) and finally, these nameservers have an A record for “test.panw.edu.” The IP address 75.126.101.247 is provided back to resolver 304 (S7) which in turn provides it to client 302, which can now visit the website.

Among other features, the DNS system was designed to be highly available, fault tolerant, and provide quick responses. Unfortunately, these features can also be leveraged by a malicious individual for nefarious purposes. Suppose client device 302 has been compromised (e.g., malware 130 has compromised client device 302) and an attacker would like to use client device 302 to help perpetrate a DDoS attack. The attacker has registered the domain, “attacker.com,” and causes client device 302 to make a DNS query for the domain, “000.attacker.com” which does not exist (is an NXNS domain). In this scenario, the same sequence of events S2-S6 occurs as in the benign scenario (e.g., querying root 306, querying an applicable TLD nameserver (ns1.com), and querying an applicable SLD nameserver (ns.attacker.com)). However, in this scenario, SLD nameserver 308 is malicious (and under the control of the attacker). Its response, rather than being an IP address, is to instruct resolver 304 to query a set of SLD nameservers that are not under the control of the attacker (which is allowed by the DNS recursive protocol). In this example, the instructions refer to nonexistent victim nameservers.

In a typical, benign DNS resolution scenario, a handful of legitimate nameservers will be provided as answers (e.g., ns1.edu and ns2.edu or ns1.panw.edu and ns2.panw.edu). At each step along the way, querying all of the returned nameservers simultaneously represents a low communication overhead while getting the benefits of, e.g., quick responses, high availability, and fault tolerance. However, the DNS protocol allows for many more nameservers to be provided in a response. This can be exploited by the operator of attacker.com who could, for example, cause nameserver 308 to respond with hundreds of randomly generated NXNS domains purporting to belong to the victim's DNS hierarchy. Following the DNS protocol, resolver 304 will then query all of the NXNS domains (e.g., 111.victim.com, 222.victim.com, etc.) in parallel, flooding the traffic between resolver 304 and victim.com's legitimate nameservers. The packet amplification factor can be as high as 1620×, subjecting both the resolver and the victim nameservers to DDoS attacks (particularly if many different compromised clients are coordinated by the attacker to simultaneously make such NXNS queries). In addition to targeting SLD nameservers, this type of attack can also be used against TLD and root nameservers (e.g., by attack server 308 varying the different components included in its response to queries).

One way to mitigate some of the harm that NXNS attacks can pose is to modify resolver behavior (e.g., to limit the number of nameserver domains contacted per referral response). While this approach might be taken by large cloud public DNS resolvers (e.g., provided by Google or CloudFlare) with teams of sophisticated engineers, smaller organizations (e.g., a typical enterprise or small business entity) using edge resolvers or relying on their ISPs' resolvers might not be in a position to modify resolver behavior, lack the technical acumen to do so, or even know that such an action should be taken. An alternate approach is for data appliance 112 and/or security platform 102 to provide protection, e.g., to a resolver operating on behalf of network 110. Further, by identifying attack domains (using embodiments of techniques described herein), additional protections can be achieved (e.g., by identifying compromised client devices and taking remedial action).

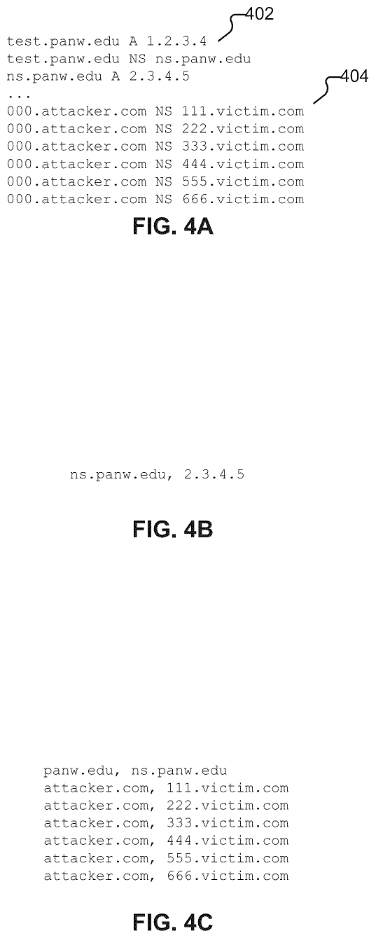

FIG. 4A is a representation of a portion of passive DNS information stored in HDFS 214. The passive DNS information includes both queries (e.g., issued by client devices) and responses returned (e.g., by authorities). A given line in FIG. 4A corresponds to a unique query and has a query type and a response (e.g., an A record response (402) or an NS referrer response (404)). Each line can be considered an event, which has a corresponding timestamp (not pictured). As will be described in more detail below, statistical information can be generated using portions of passive DNS information to help detect attack domains. Returning to FIG. 2, in various embodiments, platform 202 includes a passive DNS (pDNS) analyzer 224. An example way to implement pDNS analyzer 224 is as a set of one or more scripts authored in an appropriate scripting language. As mentioned above, platform 202 receives/processes a very large amount of passive DNS information each day. One task of pDNS analyzer 224 is to efficiently determine from that information any candidate attack domains. FIG. 4B illustrates an example of a set of valid NS records that can be extracted from pDNS information by pDNS analyzer 224 (e.g., by using one or more appropriate query tools, such as a Pig script or BigQuery script). Using the lines depicted in FIG. 4A as input, pDNS analyzer 224 receives a dataset of hosts that are nameservers that also resolve to IP addresses (have “A records”). Not included are non-nameserver hosts that have A records (e.g., host test.panw.edu) or nameserver hosts that do not have corresponding A records (e.g., any of the *.victim.com entries). FIG. 4C illustrates a domain to nameserver mapping that can be extracted from pDNS information by pDNS analyzer 224. Again using the lines depicted in FIG. 4A as input, pDNS analyzer 224 receives a dataset that pairs each domain (at the SLD level) to a nameserver.

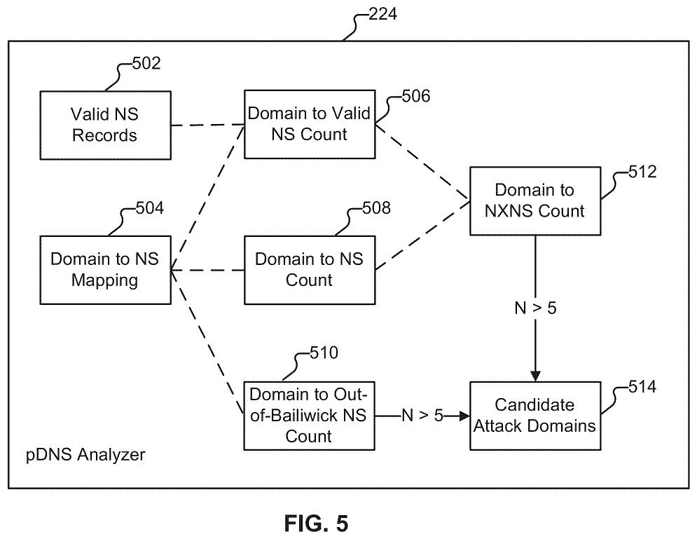

FIG. 5 illustrates various examples of data used by pDNS analyzer 224 to determine candidate attack domains in various embodiments. As mentioned above, pDNS analyzer 224 can generate (as 502) a set of valid NS records and (as 504) domain to NS mapping information. Records 502 and 504 can then be used to generate various counts. Domain to Valid NS count 506 can be obtained by joining and aggregating 502 and 504. Domain to NS Mapping 504 is aggregated to obtain a Domain to NS count (508) which indicates the number of NS records each domain points to. Domain to NXNS count 512 can be obtained by computing a mapping from each domain to the number of NXNS records it points to by subtracting count 506 from count 508.

Out-of-Bailiwick is a term that explains whether a response in which the nameserver is answering is authoritative for an ancestor of the owner name in the response. Using the example data shown in FIG. 3, “Ask.panw.edu at ns1.panw.edu” is an In-Bailiwick response, while “Ask 000.attacker.com at 111.victim.com” is an Out-of-Bailiwick response. Count 510 can be obtained by computing a mapping from each domain to the number of Out-of-Bailiwick NS records it points to by aggregating 504. In the example shown in FIG. 5, if counts 510 and 512 each exceed 5 for a given domain, that domain is designated a candidate attack domain 514. Other approaches to evaluating pDNS information for candidates can also be used, and/or different threshold requirements can be applied in evaluating/designating candidate attack domains.

Returning to FIG. 2, candidate attack domains identified by pDNS analyzer 224 are provided to validator 226 which actively probes candidate attack domains to validate. In an example implementation (authored as a python script), for a given candidate attack domain, the validator gets authoritative nameservers for the domain and issues an A query against the obtained nameservers to make sure that no A records are included. The validator then checks the DNS responses to compute a packet amplification factor (PAF). An example way of determining the PAF is as 2*F*(1+5TC), where F is the total number of DNS requests generated by the amplifier (the number of NXNS records), and TC is 1 if the F response size is over 512 bytes (triggers fall back to a TCP connection) or 0 otherwise. Validated domains with a PAF that exceeds a threshold can be designated as confirmed attack domains and used for a variety of purposes (e.g., provided by security platform 102 to data appliance 112) for enforcement.

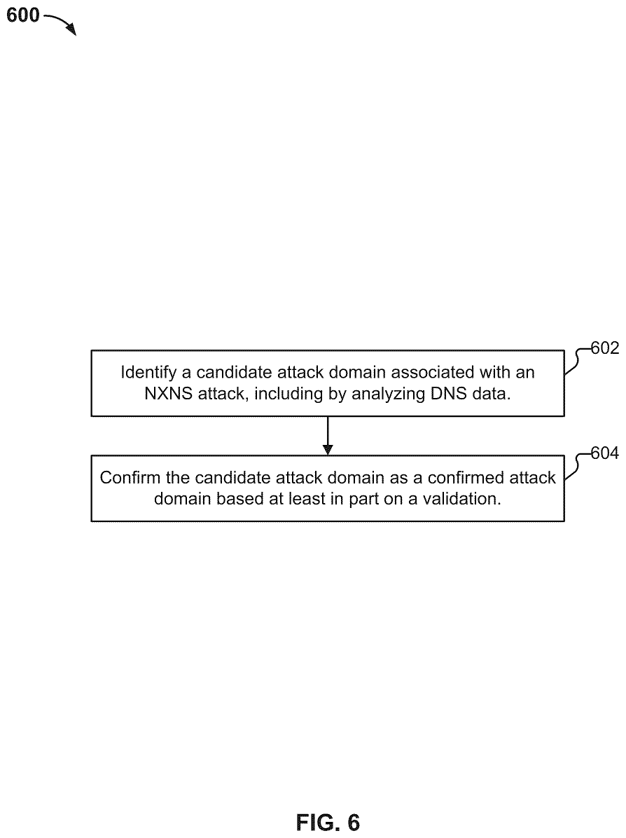

FIG. 6 illustrates an embodiment of a process for identifying an attack domain associated with an NXNS attack. In various embodiments, process 600 is performed by platform 202, and in particular by pDNS analyzer 224 working in concert with validator 226. One example way to implement pDNS analyzer 224 and/or validator 226 is using a script (or set of scripts) authored in an appropriate scripting language (e.g., python), using MapReduce (as applicable). Process 600 begins at 602 when DNS data is analyzed and a candidate attack domain associated with an NXNS attack is identified in conjunction with that analysis. Various techniques for performing such analysis are described above, for example, in conjunction with FIG. 5. At 604, the candidate attack domain is confirmed as a confirmed attack domain based at least in part on a validation (e.g., performed by validator 226). The confirmed attack domain can be stored in HDFS 214 or another appropriate location, as applicable. Further, platform 102 can provide the confirmed attack domain to data appliances such as data appliance 112. Data appliance 112 (e.g., via DNS module 114) can monitor DNS requests (e.g., made by client 104) for matches against the confirmed attack domain and take one or more remedial actions in response (e.g., prevent the client from communicating with the confirmed attack server, prevent a resolver from communicating with the confirmed attack server (or its reported nameservers), isolate the client from other nodes within an enterprise network, etc.). In various embodiments, and where applicable, platform 102 can provide an alert (or otherwise inform), e.g., to an entity from which the DNS query information was collected. As one example, suppose DNS query information provided by appliance 112 to platform 102 includes an event in which client device 104 attempts to obtain DNS information for “attacker.com” (which has not yet been determined to be an attack domain). When platform 102 determines that “attacker.com” is malicious (e.g., using process 600), platform 102 can alert appliance 112 that a node in network 110 has been compromised (and an administrator of network 110 can further investigate to determine that the node was client 104 and take appropriate remedial actions, such as removing client 104 from the network, investigating how client 104 became infected, etc.).

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
a processor configured to:
identify a candidate attack domain associated with an NXNS attack based at least in part on an analysis of DNS data; and
confirm the candidate attack domain as a confirmed attack domain based at least in part on a validation; and
a memory coupled to the processor and configured to provide the processor with instructions.

2. The system of claim 1, wherein the DNS data comprises passive DNS records.

3. The system of claim 1, wherein the analysis includes extracting a dataset of hosts that (1) are nameservers and (2) resolve to an IP address from the passive DNS records.

4. The system of claim 1, wherein the analysis includes extracting a dataset that pairs a domain to a nameserver.

5. The system of claim 4, wherein the domain is paired at an SLD level.

6. The system of claim 1, wherein the analysis includes joining and aggregating (1) a dataset of hosts that (a) are nameservers and (b) resolve to an IP address with (2) a dataset that pairs a domain to a nameserver.

7. The system of claim 1, wherein the analysis includes determining a count that indicates a number of NS records a domain points to.

8. The system of claim 1, wherein the analysis includes determining a count of NXNS domains.

9. The system of claim 1, wherein the analysis includes determining a number of Out-of-Bailiwick NS records a domain points to.

10. The system of claim 1, wherein confirming the candidate attack domain includes actively probing the candidate attack domain.

11. The system of claim 1, wherein confirming the candidate attack domain includes obtaining one or more authoritative nameservers for the candidate attack domain and issuing an A query against the obtained nameservers.

12. The system of claim 1, wherein confirming the candidate attack domain includes checking DNS responses to determine a packet amplification factor.

13. The system of claim 1, wherein the processor is further configured to provide the confirmed attack domain to a data appliance for policy enforcement.

14. A method, comprising:
identifying a candidate attack domain associated with an NXNS attack based at least in part on an analysis of DNS data; and
confirming the candidate attack domain as a confirmed attack domain based at least in part on a validation.

15. A computer program product embodied in a non-transitory computer readable medium and comprising computer instructions for:
identifying a candidate attack domain associated with an NXNS attack based at least in part on an analysis of DNS data; and
confirming the candidate attack domain as a confirmed attack domain based at least in part on a validation.
